(19) United States
(12) Patent Application Publication
(10) Pub. No.: US 2017/0036815 A1
(43) Pub. Date: Feb. 9, 2017

(54) Tubular Novelty Container

(71) Applicant: Juanita Treadwell, Mesita, CO (US)

(72) Inventor: Juanita Treadwell, Mesita, CO (US)

(21) Appl. No.: 15/228,742

(22) Filed: Aug. 4, 2016

Related U.S. Application Data
(60) Provisional application No. 62/201,507, filed on Aug. 5, 2015.

(51) Int. Cl. B65D 25/20; A44B 18/00; F16B 1/00; F16B 11/00; F16B 19/04; B65D 43/02; F16B 15/00

(52) U.S. Cl. CPC B65D 25/20; B65D 43/0214; B65D 43/0225; A44B 18/00; F16B 15/00; F16B 11/006; F16B 19/04; F16B 1/00; F16B 2001/0035

(57) ABSTRACT

A tubular novelty container, comprising: a preferably configured element to resemble a tubular cylindrical member; a removable cap element; a built-in accessible storage chamber element; a attachments member area; a tubular novelty container element with interchangeable designs, prints, and advertisements to reflect; camouflage; a cause; sports; valentines; holidays; Native American art; culture; religion; employment; tools; cars; finance; real estate; retail; manufacturing; construction; politics; political; hunting; vegetables; fruits; tamales; food; restaurant; flowers; cactus; the likes; and, a tubular novelty container configured so that it is attachable, wherein when a cap is openable and closable via a user, a stored item is easily accessible to the user.

### BACKGROUND

Regular tubular novelty container novelties do not allow the novelty to be attached to caps, hats, backpacks, or just about anything that comes to mind; and, tubular novelty containers do not have a attachment area allowing it to be held on a magnetically metal surface, such as a refrigerator and other things.

Presently there is no solution for people to carry around a tubular novelty container; and, there is no solution to have easy access to stored items in another convenient way held on a magnetically metal surface.

### SUMMARY

The present invention seeks to provide a solution to this problem by providing shown a tubular novelty container, comprising: a preferably configured element to resemble a tubular cylindrical member; a removable cap element; a built-in accessible storage chamber element; a attachments member area; a tubular novelty container element with interchangeable designs, prints, and advertisements to reflect; camouflage; a cause; sports; valentines; holidays; Native American art; culture; religion; employment; tools; cars; finance; real estate; retail; manufacturing; construction; politics; political; hunting; vegetables; fruits; tamales; food; restaurant; flowers; cactus; the likes; and, a tubular novelty container configured so that it is attachable, wherein when a cap is openable and closable via a user, a stored item is easily accessible to the user.

The present invention seeks to provide a solution by providing a molded tubular novelty container which can be attached to caps, hats, backpacks, or just about anything that comes to mind; and, it seeks to provide a solution to this problem by providing a tubular novelty container for easy access to stored items in areas where there is a magnetic metal surface. The present invention can be placed and held on a magnetically metal surface, such as a refrigerator.

In particular, the present invention provides the method for storage with a convenient way to carry around the tubular novelty container which can be attached to caps, hats, backpacks, or just about anything that comes to mind. In particular, the present invention provides the method for storage and the magnetic method. In particular, the present invention provides a user easy access to stored items.

Preferably, it comes with a cap.

Preferably, it provides a compartment for storage.

Preferably, it provides a attachments area.

Preferably, the attachments area is on the back of the tubular novelty container.

The present invention will now be more particularly described, with reference to the accompanying drawings, by way of example only and in no way limiting the scope of the invention, in which:

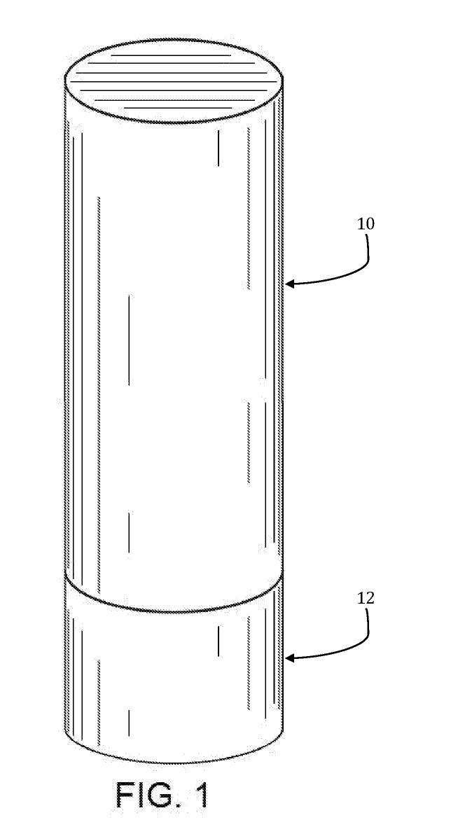

FIG. 1 is a perspective view of a tubular novelty container with a particular reference to a cap member;

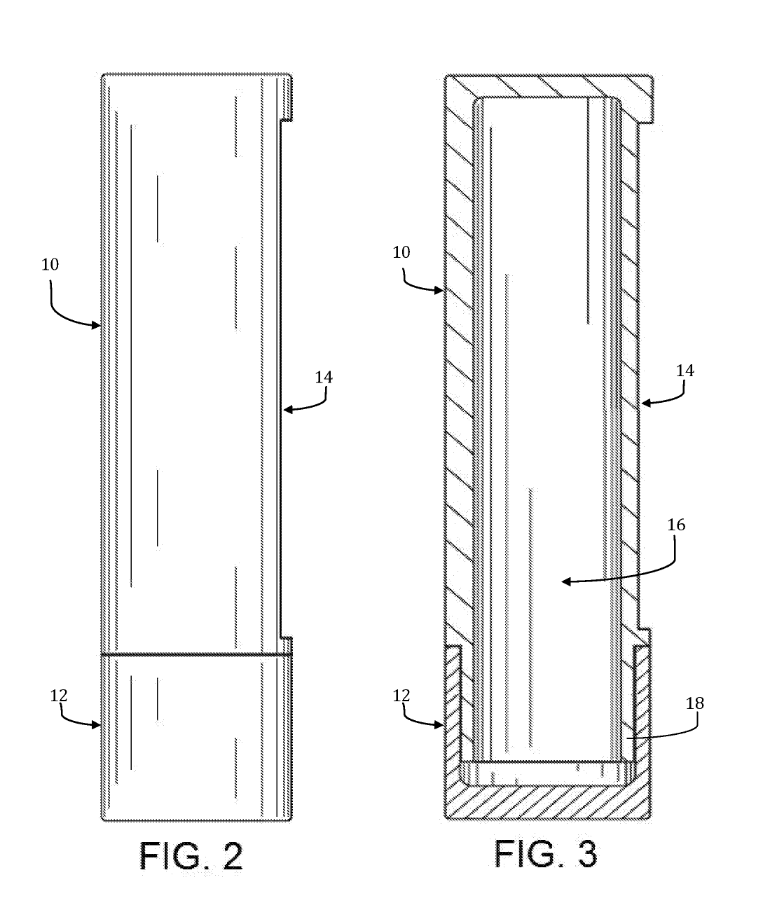

FIG. 2 is a back view with attachments area member and front side view thereof, front and side views being a mirror image of the tubular novelty container with particular reference to a cap member;

FIG. 3 is a cutaway back and front views thereof, with particular reference to a slip fit pressed on cap element combination of the present invention, in which the storage chamber member is shown, front and side views being a mirror image of the tubular novelty container;

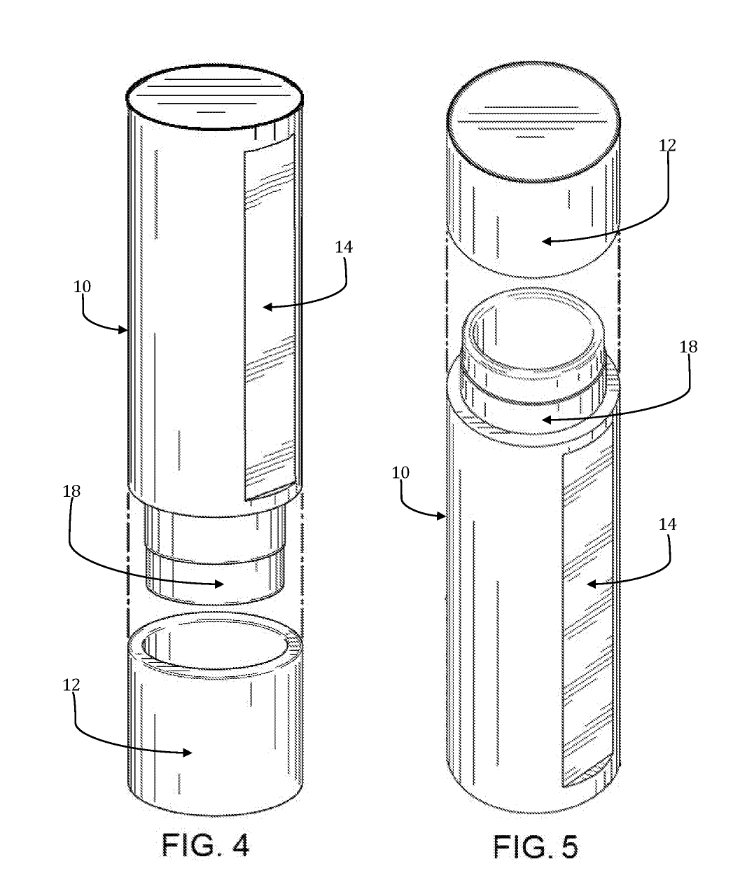

FIG. 4 is an exploded perspective view thereof; and,

FIG. 5 is another exploded perspective view.

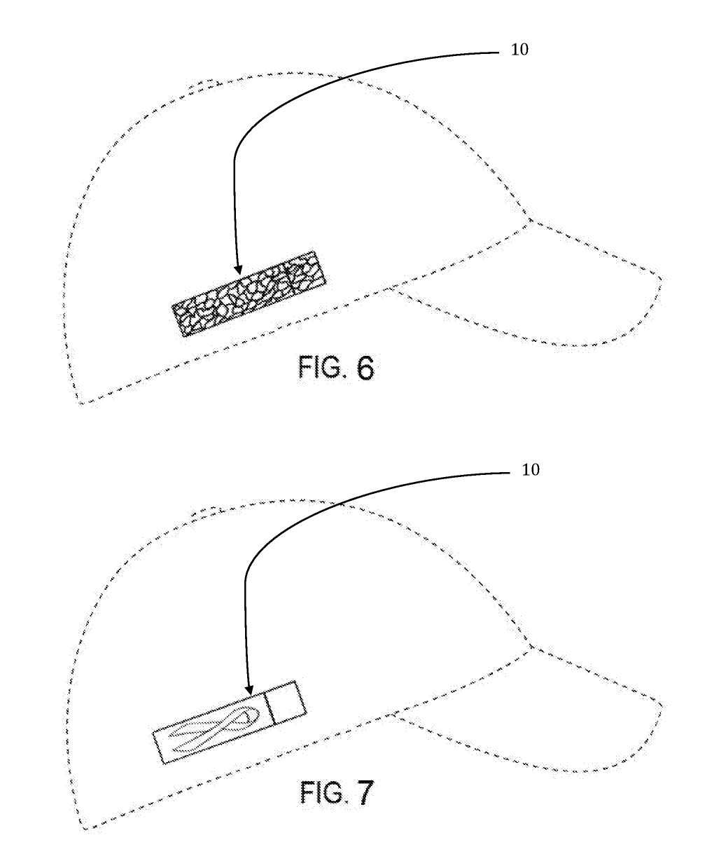

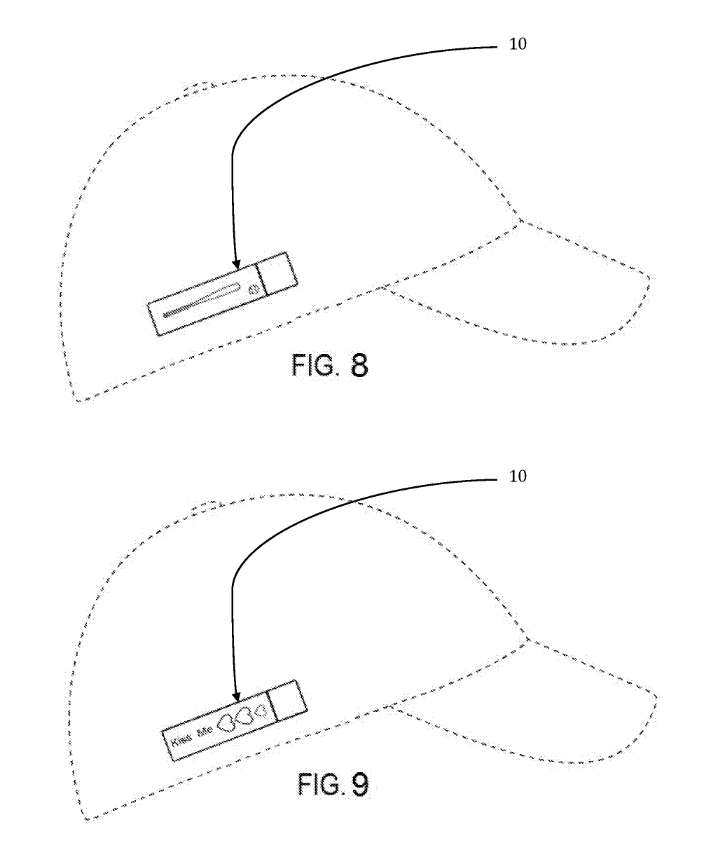

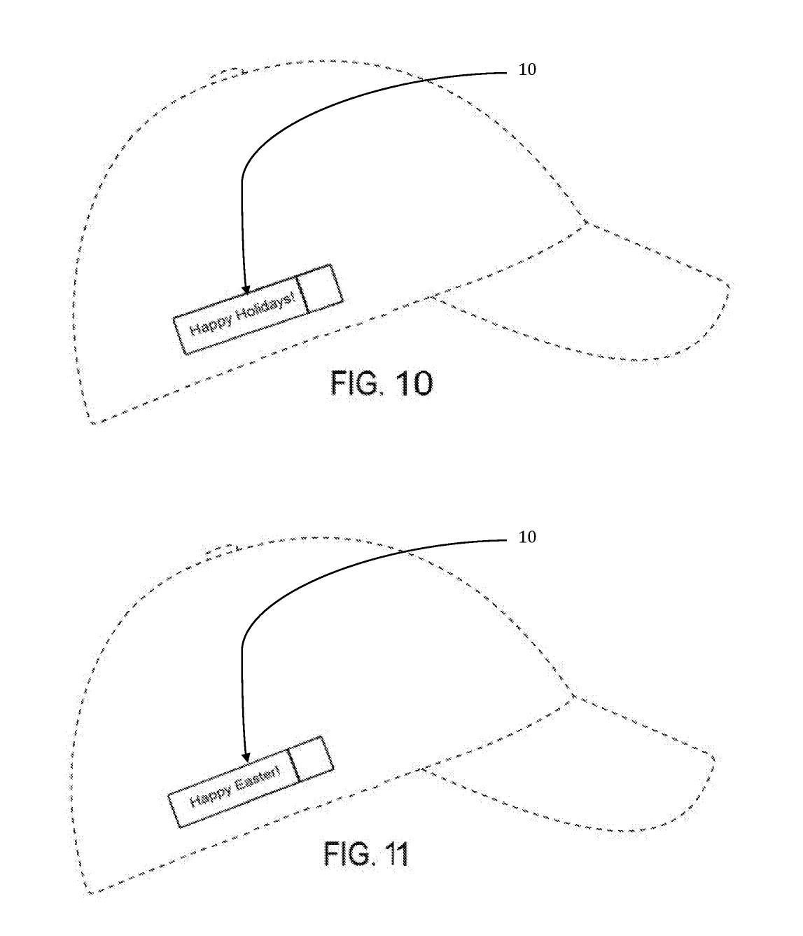

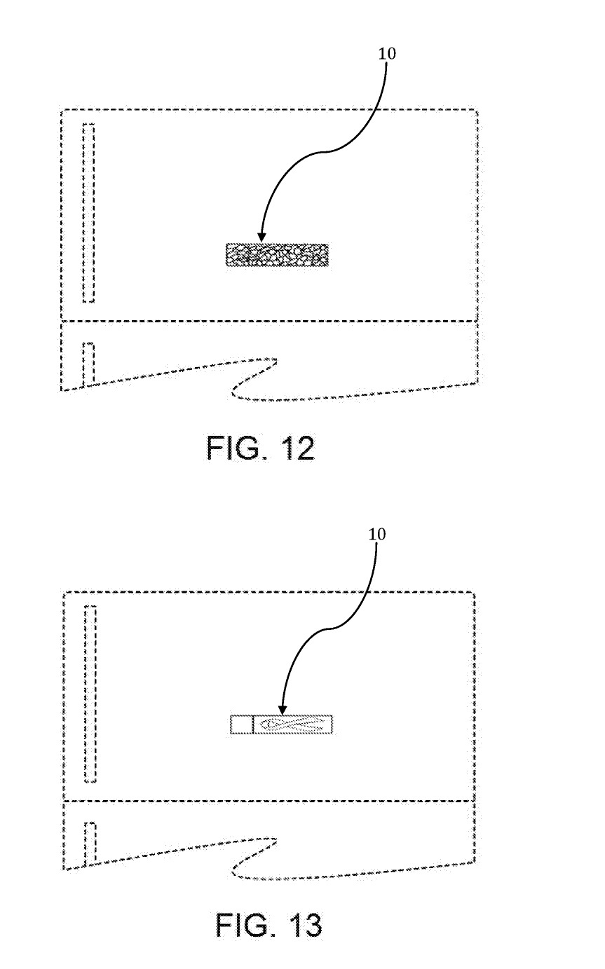

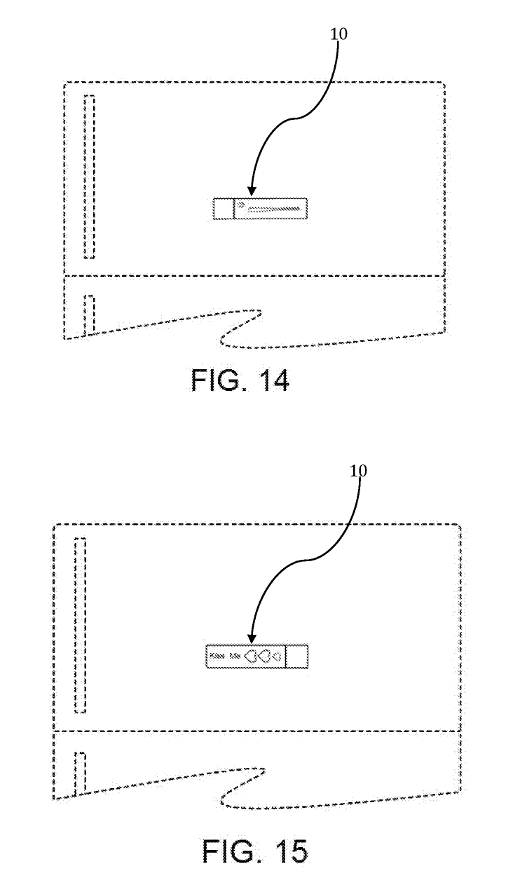

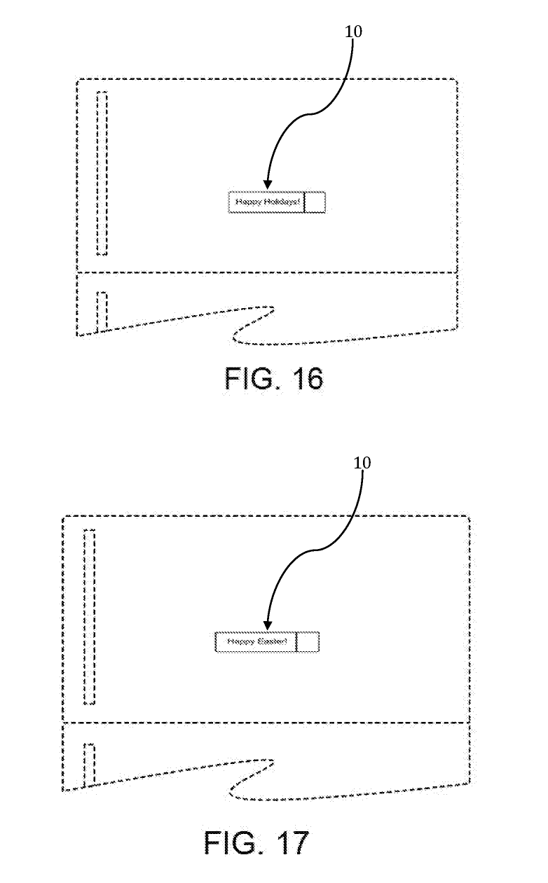

The broken lines in FIGS. 6-17 illustrate environmental structure and form no part of the claimed tubular novelty container.

### DETAILED DESCRIPTION

The present invention seeks to provide a solution to this problem by providing shown a tubular novelty container, comprising: a preferably configured element to resemble a tubular cylindrical member; a removable cap element; a built-in accessible storage chamber element; a attachments member area; a tubular novelty container element with interchangeable designs, prints, and advertisements to reflect; camouflage; a cause; sports; valentines; holidays; Native American art; culture; religion; employment; tools; cars; finance; real estate; retail; manufacturing; construction; politics; political; hunting; vegetables; fruits; tamales; food; restaurant; flowers; cactus; the likes; and, a tubular novelty container configured so that it is attachable, wherein when a cap is openable and closable via a user, a stored item is easily accessible to the user.

There is shown a detachable cap 12 for accessing the storage chamber 16 located within the tubular novelty container 10.

Referring to the attachments area 14 is for illustration purposes only.

The built-in accessible storage chamber 16 is to hold and transport items.

Referring to the slip fit press on 18 is for illustration purposes only.

The invention will now be described in use, with reference to a preferred embodiment, in no way limiting a scope of the invention.

In use, when a tubular novelty container is attached to a cap, hat, backpack, or just about anything that comes to mind, a user no longer has to go searching for a stored item; and, when in use such as placed and held on a magnetically metal surface such as a refrigerator the tubular novelty container provides a user easy access to the stored item.

Without the invention a user would have to go looking for the item.

The embodiments described above are provided by way of example only, and various other modifications will be apparent to persons skilled in the art without departing from the scope of the invention as defined in the appended claims.

1. A tubular novelty container, comprising:
a preferably configured element to resemble a tubular cylindrical member;
a removable cap element;
a built-in accessible storage chamber element;
a attachments member area;
a tubular novelty container element with interchangeable designs, prints, and advertisements to reflect;
camouflage;
a cause;
sports;
valentines;
holidays;
Native American art;
culture;
religion;
employment;
tools;
cars;
finance;
real estate;
retail;
manufacturing;
construction;
politics;
political;
hunting;
vegetables;
fruits;
tamales;
food;
restaurant;
flowers;
cactus;
the likes; and,
a tubular novelty container configured so that it is attachable, wherein when a cap is openable and closable via a user, a stored item is easily accessible to the user.

2. A tubular novelty container as claimed in claim 1, wherein a removable member is a cap element configured to facilitate access to a storage chamber element by a user.

3. A tubular novelty container, as claimed in claim 2, wherein there is provided a removable cap member, wherein the removable cap element is at least one of:
slip fit;
press on;
threaded;
safety,
configured to facilitate access to the storage chamber element by a user.

4. A tubular novelty container, as claimed in claim 1, wherein there is provided a attachments member area, wherein the attachment is at least one of:
tie tacks;
velcro;
glue;
pins;
weld(s);
rivet(s);
press on;
clip(s);
magnet(s); and
filament,
placed in the attachments area on back of the tubular novelty container.
